(19) United States
(12) Patent Application Publication
(10) Pub. No.: US 2007/0144878 A1
(43) Pub. Date: Jun. 28, 2007

(54) Driving bracket for an electrical switch

(76) Inventors: Frederick J. Brown, Stokesdale, NC (US); Sheila L. Brown, Greensboro, NC (US)

Correspondence Address: Michael M. Rickin;ABB Inc., Legal Dept. - 4U6, 29801 Euclid Avenue, Wickliffe, OH, 44092-1832, US

(21) Appl. No.: 11/318,774

(22) Filed: Dec. 27, 2005

(51) Int. Cl. H01H 31/28

(52) U.S. Cl. 200/48 R

(57) ABSTRACT

A driving bracket for use in the power transmission and distribution industry that uses an electrically conductive portion to route current to a handle of a current interrupter when the current interrupter shunts current away from opening electrical switch contacts. The electrically conductive portion is mounted on a swing arm assembly and the driving bracket and the handle eliminate the previously used dedicated electrical contacts as well as various internal wiring required to connect those contacts.

### FIELD OF THE INVENTION

The present invention relates to a driving bracket, and more particularly, to a driving bracket that provides a current path to a trigger arm assembly of a current interrupter.

### BACKGROUND OF THE INVENTION

Electrical switches are used in the transmission and distribution of electrical power to control the flow of electricity through the power network. Typically the switch has at least one moveable contact and at least one stationary contact. When closed, the contacts are touching and current is flowing through the switch. When the utility company determines that the flow of current through the power circuit is to be interrupted, the switch is opened and the flow of electricity is broken. One problem associated with the electrical switch is that during the opening of the switch an arc may occur across the contacts when they separate. To alleviate this problem, utility companies use current interrupters in conjunction with the electrical switch.

Current is diverted from the switch contacts to the current interrupter when the contacts begin to separate. During the opening sequence of the switch, current flows through both the switch contacts as well as the current interrupter. This allows an alternate current path to exist when the contacts separate. When the contacts have separated a predefined distance, internal contacts within the current interrupter separate, thus breaking the flow of current. The break in the current path occurs within the body of the current interrupter and eliminates any arcing across the electrical switch contacts. Typically current interrupters are rated to handle voltages in the range of 1 kV up to 38 kV and currents up to about 900 amps.

U.S. Pat. No. 4,103,129 issued to Evans et al., describes a current interrupter which uses two external electrical contacts on the exterior housing of the current interrupter to provide the alternate current path. In U.S. Pat No. 5,057,654 issued to Meyer et al., the two external contacts are reduced to one external contact protected by an overhanging portion of the body of the current interrupter. Also described in Evans and Meyer is the use of a trigger arm assembly to facilitate the opening and closing of the current interrupter.

As described in Meyer and Evans, the trigger arm assembly provides only a mechanical means of moving the internal contacts of the current interrupter. The trigger arm assembly of the present invention not only provides the mechanical means necessary to move the current interrupter internal contacts but also is the electrical contact through which current flows. The present invention also provides a current path from the electrical switch to the trigger arm assembly.

### SUMMARY OF THE INVENTION

A driving bracket for use in an electrical switch assembly, said driving bracket mounted on a swing arm of said electrical switch assembly and providing an electrical current path to a trigger arm assembly of a current interrupter mounted on said electrical switch assembly, said driving bracket comprising a conductive portion which makes electrical contact with said trigger arm assembly when said swing arm moves from a first position to a second position.

A current switch assembly for use in the power transmission and distribution industry said current switch assembly comprising a swing arm assembly, a driving bracket mounted on said swing arm assembly, said driving bracket comprising a conductive portion, a current interrupter mounted on said current switch assembly, said current interrupter comprising a trigger arm assembly wherein electrical current flows through said current interrupter when said conductive portion makes electrical contact with said trigger arm assembly as said swing arm assembly moves from a first position to a second position.

### BRIEF DESCRIPTION OF THE DRAWINGS

The invention is further described in the detailed description that follows, by reference to the noted drawings, by way of non-limiting illustrative embodiments of the invention, in which like reference numerals represent similar elements throughout the several views of the drawings, and wherein:

FIG. 1 illustrates an exploded view of a current interrupter switch assembly in accordance with the present invention.

FIG. 2 illustrates a side perspective the current interrupter switch assembly of FIG. 1 rotated along Axis 2-2.

FIG. 3A illustrates a front perspective view of a driving bracket assembly and a trigger arm assembly embodied in accordance with the present invention as it moves from the closed to the open position.

FIG. 3B illustrates a front perspective view of the driving bracket assembly and trigger arm assembly embodied in accordance with the present invention moving from the open to the closed position.

FIG. 4 illustrates a cross-sectional front view of the current interrupter in accordance with the present invention.

FIG. 5 illustrates a side view of the current interrupter of FIG. 4.

FIG. 6 illustrates a front perspective exploded view of the internal operating components of a current interrupter in accordance with the present invention.

FIG. 7 illustrates a graph of the characteristics of a spring, known as a charging spring, which is used in the interrupter of the present invention to provide the additional force to separate the external contacts of the switch assembly and to keep the contacts from parting as the blade opens and the contact on the drive bracket moves along the handle of the interrupter.

FIG. 8 illustrates a cross-sectional front view of a current interrupter with the internal components removed.

FIG. 9 illustrates a front view of a cover for a current interrupter.

### DETAILED DESCRIPTION OF ILLUSTRATIVE EMBODIMENTS

The present application incorporates by reference U.S. Pat. Nos. 4,103,129 (“the '129 Patent”) and 5,057,654 (“the '654 Patent”) in their entirety.

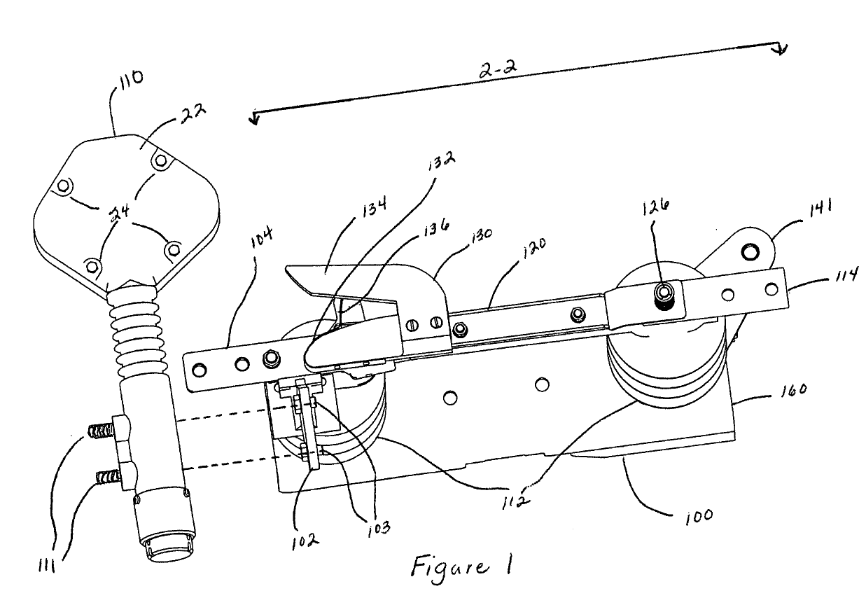

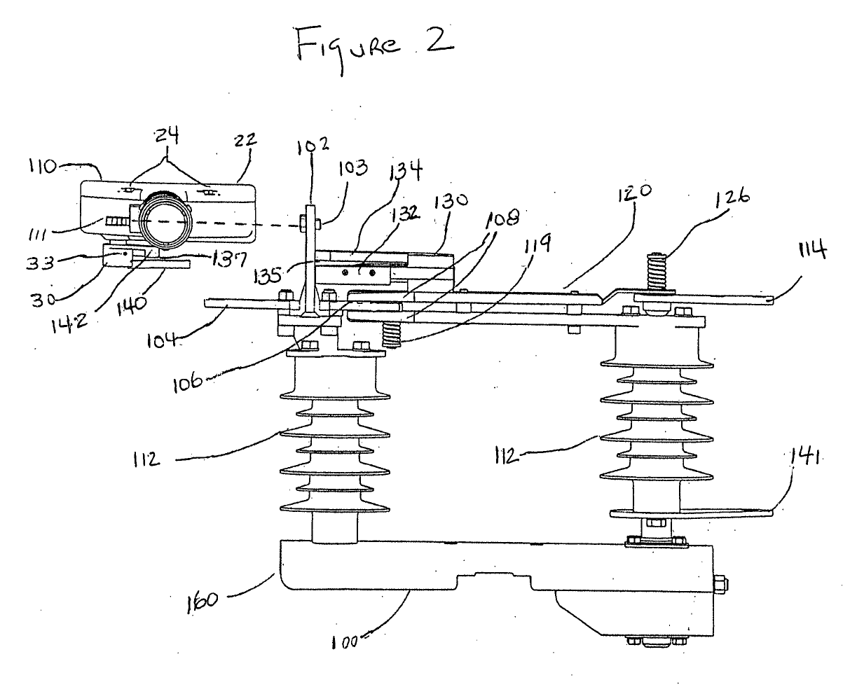

FIGS. 1 and 2 display an exploded view of an interrupter switch assembly pole 100, embodied in accordance with the present invention, in a closed position. FIG. 1 of the present application is similar to FIG. 1 of the '654 patent and shows a top view of the interrupter switch assembly 100. FIG. 2 shows a side view of the interrupter switch assembly 100 along the 2-2 axis of FIG. 1. For illustrational purposes, FIGS. 1 and 2 show a current interrupter 110 detached and situated above the interrupter switch assembly 100. Interrupter switch assembly 100 has a mounting bracket 102 with holes 103. Current interrupter 110 has mounting bolts 111 which mate with holes 103 to thereby allow interrupter 110 to be attached to assembly 100.

The mounting bracket 102 includes a first electrical connector 104 for connecting the interrupter switch assembly 100 into a power distribution network (not shown in FIGS. 1 and 2). As shown in FIG. 2, attached to mounting bracket 102 is a single tongue shaped stationary switch contact 106 which together with connector 104 form a single piece. Contact 106 extends through a two part moveable switch contact 108. Switch contact 106 is wedged in between the two part moveable switch contact 108 and a spring 119 provides a compresssional force to keep switch contacts 106 and 108 in electrical contact when the interrupter switch assembly 100 is closed and conducting current.

The two part moveable switch contact 108 is mounted on the upper end of a swing arm assembly 120 which is made of an electrically conductive material. At the lower end of the swing arm assembly 120 is a second connector 114 that provides the other electrical connection into the power distribution network. When the interrupter switch assembly 100 is in the closed position, current flows from the first connector 104 through the switch contacts 106 and 108, through swing arm assembly 120 and out the second electrical connector 114. Electrically isolating the swing arm assembly 120 from the base 160 used to mount the switch assembly 100 to the power distribution network are non-conductive insulators 112.

A lever arm 141 is connected to the swing arm assembly 120 at the base of insulator 112 located at pivot point 126. The interrupter switch assembly 100 is opened by rotating lever arm 141 around the pivot point 126 in a clockwise direction. The lever arm 141 may be moved by a motorized device or other mechanical movement means. The movement of the lever arm 141 causes the swing arm assembly 120 to rotate in the same direction. When the swing arm 120 rotates clockwise, the moveable switch contacts 108 slide along switch contact 106 until they separate.

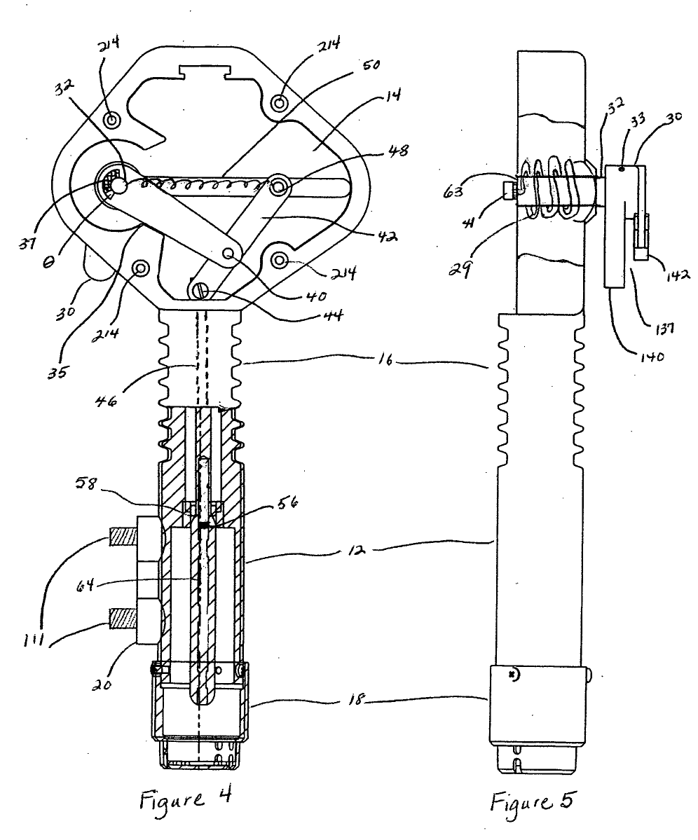

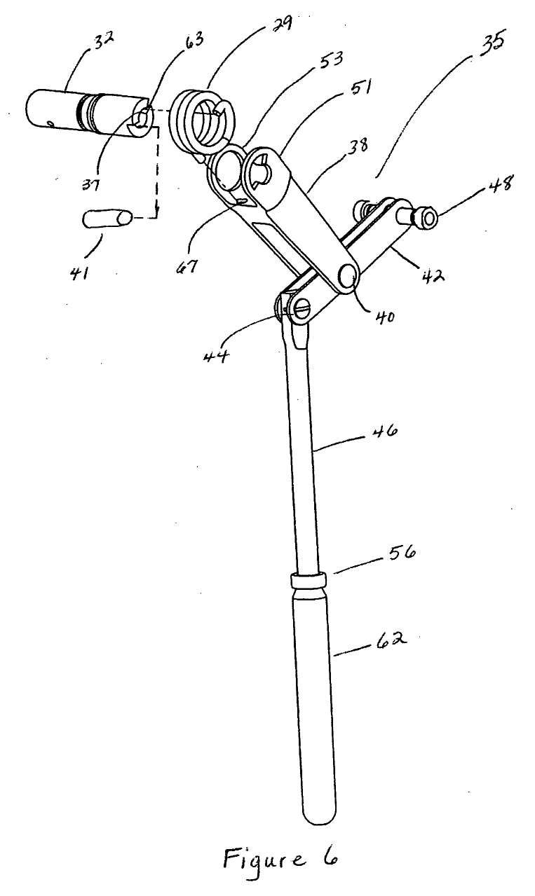

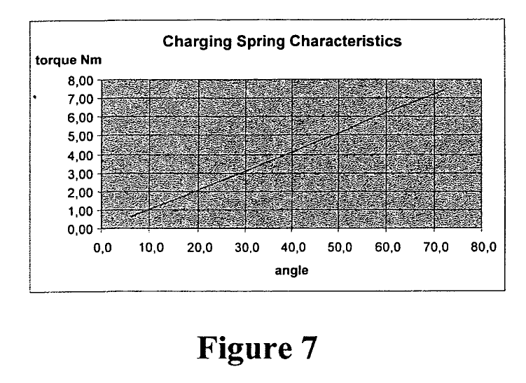

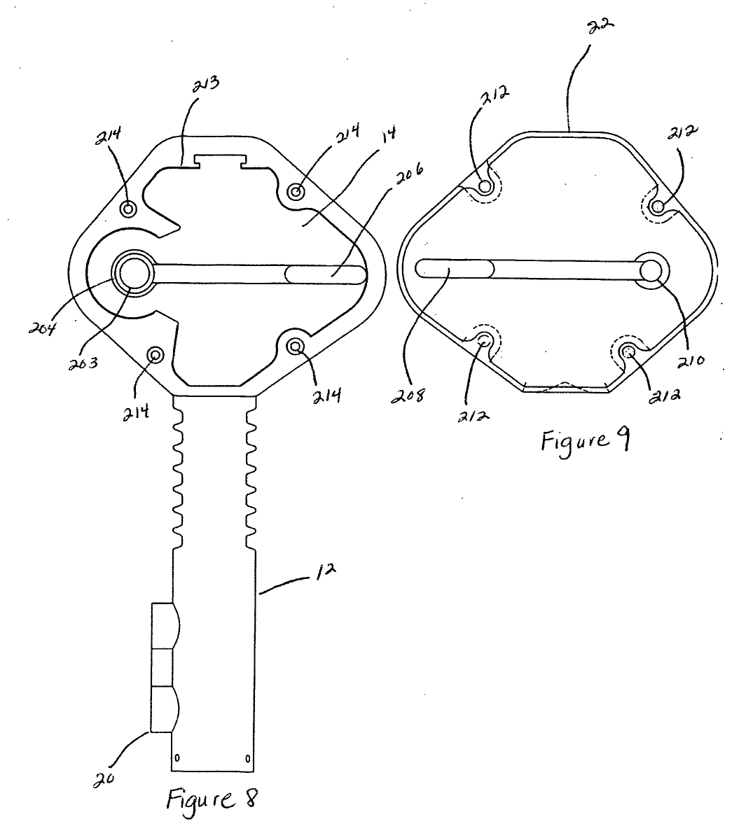

As is well known to those of ordinary skill in the power transmission and distribution arts, the role of the current interrupter 110 is to divert current away from the contacts 106 and 108 before they separate. This is accomplished by shunting the current through the current interrupter 110 after the swing arm assembly 120 begins to move. As the swing arm assembly 120 rotates counterclockwise, the contacts 108 begin to slide along contact 106. As is described in detail below, when the swing arm assembly moves from the closed position to the open position, current is routed through the current interrupter 110. After contacts 106 and 108 separate, current still flows through the current interrupter 110. After sufficient separation of the contacts 106 and 108, internal contacts (stationary contact 58 and moveable contact 56 shown in FIG. 4) within the current interrupter 110 separate. Any arcing associated with the separation of the internal contacts takes place within the controlled environment inside the current interrupter 110.

One aspect of the present invention is to shunt electrical current directly through a trigger arm assembly 30 (shown in FIG. 2) of the current interrupter 110 when the contacts 106 and 108 begin to separate. Referring back to FIG. 2, current is directed to an opening handle 140 of the trigger arm assembly 30 through a conductive portion 132 of a driving bracket 130. In one embodiment, the trigger arm assembly 30 is made of an electrically conductive material such as brass or other similar metal alloy. The conductive portion 132 is electrically connected to the pair of moveable contacts 108. When the interrupter switch assembly 100 is closed, the conductive portion 132 and the opening handle 140 are not in electrical contact, thus no current is flowing through the current interrupter 110. When the interrupter switch assembly 100 moves from the closed position to the open position, the movement of the swing arm assembly 120 brings the conductive portion 132 into contact with the opening handle 140 which allows current to flow through the conductive portion 132 in parallel with the switch contacts 106 and 108.

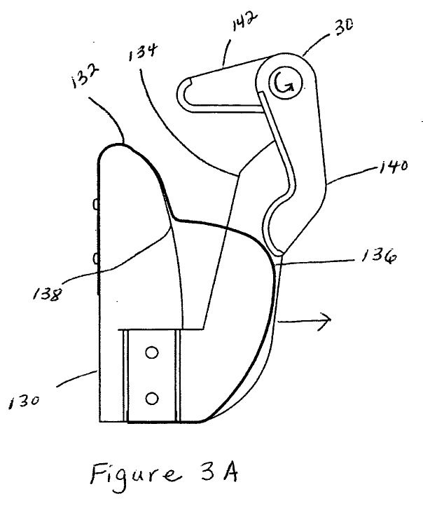

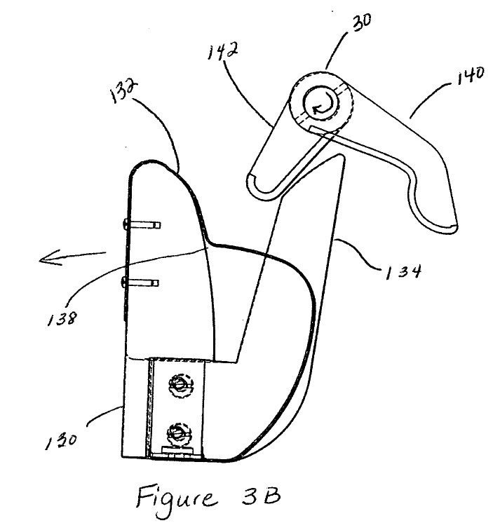

FIG. 3A shows the driving bracket 130 positioned with the trigger arm assembly 30 when the swing arm assembly 120 is moving from the closed position to the open position. When the swing arm assembly 120 rotates to the open position, the conductive portion 132 makes contact with the opening handle 140 along an upper lateral edge 136. When contact is established between the conductive portion 132, and the opening handle 140, a current path exists through the current interrupter 110. While current is flowing through the current interrupter 110, the swing arm assembly 120 continues to rotate around pivot point 126 and the two part contact 108 continues to move. The present invention is designed to allow the contacts 106 and 108 to separate as the opening handle 140 travels down the lateral edge 136. The shape of the opening handle 140 and the contour of the lateral edge 136 up to point 138 cause the trigger arm assembly 30 to rotate counterclockwise approximately 30°. When the opening handle 140 reaches point 138, the contacts 106 and 108 have completely separated. The continued movement of the swing arm assembly 120 causes the opening handle 140 to travel past point 138 which in turn causes the trigger arm assembly 30 to rotate counterclockwise by approximately an additional 60°. As is explained in subsequent sections, the continued rotation of the trigger arm assembly 30 past point 138 causes the internal contacts of the current interrupter 110 to separate, which results in breaking the electrical circuit.

Driving bracket 130 also consists of a non-conductive closing portion 134 which is offset from the conductive portion 132. In the embodiment shown in FIG. 2, a small gap 135 exists between the conductive portion 132 and the closing portion 134 and in that embodiment the small gap is, without limitation, approximately ¼″ (6.35 mm). The opening handle 140 of the trigger arm assembly 30 is also offset by a small gap 137 which in that embodiment is, without limitation, approximately ¼″ (6.35 mm) from a closing handle 142. When the current interrupter 110 is mounted on the interrupter switch assembly 100, the opening handle 140 aligns with the conductive portion 132 and the closing handle 142 aligns with the closing portion 134.

FIG. 3B shows the driving bracket 130 and the trigger arm assembly 30 as the interrupter switch assembly 100 moves from the open position to the closed position. When the driving bracket 130 and trigger arm assembly 30 are in this position, moveable contacts 108 are in electrical contact with stationary contact 106 (not shown in FIG. 3B). When the interrupter switch assembly 100 closes, it is important that the moveable contacts 108 make electrical contact with stationary contact 106 before the internal contacts of the current interrupter 110 touch. If the internal contacts of the current interrupter 110 are electrically connected before contacts 106 and 108 touch, flashing across the trigger arm assembly 30 and the conductive portion 134 may occur.

During the closing phase, the shape and movement of the non-conductive portion 134 as it hits the closing handle 142 causes the trigger arm assembly 30 to rotate clockwise. The clockwise rotation of the trigger arm assembly 30 causes the moveable contact 56 to move to the closed position which results in the current interrupter 110 resetting. When reset, the current interrupter 110 can conduct current when the current switch assembly 100 is reopened.

FIG. 4 displays a front cut away view of an exemplary current interrupter 110 in a closed position. FIG. 4 herein is similar to FIG. 1 of the '129 patent which displays a mirror image of a prior art current interrupter. FIG. 4 herein shows the housing 12 with the cover 22 (shown in FIG. 1 herein) removed so that the internal operating mechanisms are displayed. FIG. 5 herein illustrates a side view of the current interrupter 110 with the cover 22 removed and is similar to FIG. 2 of the '129 patent. FIG. 6 shows an exploded side perspective view of the internal operating components of the current interrupter 110 with the exception of the pair of guide springs 50. The guide springs 50, only one of which is shown in FIG. 4, are described in more detail below.

The current interrupter 110 of FIGS. 4 and 5 comprises housing 12 molded of insulating material, such as epoxy resin, and preferably cycloaliphatic epoxy resin or glass filled Polybutylene Terephthalate (PBT). Housing 12 includes operating mechanism enclosing portion 14 and insulator portion 16 which are integrally molded together and also muffler portion 18. Also integrally molded to the insulator portion 16 of the housing 12 is mounting flange 20. As described previously, the cover 22 can be secured in place by bolts 24. Alternatively, cover 22 can also be attached to the enclosing portion by other means.

FIG. 4 displays a cylindrical shaft 32 extending through enclosing portion 14 with one end of the shaft 32 located on the exterior and the other end of the shaft 32 positioned in the interior of the enclosing portion 14. On the shaft 32 is mounted a lever arm assembly 35. The lever arm assembly 35 comprises a first lever arm 38, a second lever arm 42, a guide pin 48, and a pair of guide springs 50. The end of first lever arm 38 is pivotally connected by a pin 40 to the second lever arm 42 intermediate its ends. Second lever arm 42 is pivotally connected at one end by a pin 44 to a contact rod 46. Mounted through the other end of second lever arm 42 is guide pin 48 that extends to either side of the second lever arm 42, over which is attached the pair of guide springs 50. The other end of the guide springs 50 are attached to the shaft 32 at an indentation (not shown) and at a guide spring mount 41. The guide springs 50 bias guide pin 48 towards shaft 32 and provide a compresssional force which supplements the movement of the contact rod 46.

As shown in FIG. 6, mounted around the shaft 32 in between an upper portion 51 and a lower portion 53 of the first lever arm 38 is a charging spring 29. One end of the charging spring 29 attaches to a groove 63 in the shaft 32 and the other end attaches to a spring mounting hole 67 in the first lever arm 38. The charging spring 29 is oriented to wind when the shaft 32 rotates in a counter clockwise direction.

In one embodiment of the present invention, the charging spring 29 is made of stainless steel and consists of four turns. Spring characteristics of an exemplary charging spring 29 are displayed in FIG. 7. The charging spring 29 is designed to provide a maximum rotational acceleration for the first lever arm 38 without being so stiff that the rotation of the shaft 32 fails to cause the charging spring 29 to charge. In a preferred embodiment, the charging spring 29 develops approximately 3 Nm of torque from 30° angular rotation.

Formed on the end of contact rod 46 is a movable contact 56. Movable contact 56 engages stationary contact 58 when the current interrupter 110 is in the closed position. Mounted to the end of contact rod 46 is a trailer 62 (see FIG. 6). Trailer 62 is formed of a material that produces an arc inhibiting gas upon exposure to an electrical arc. A metallic sleeve 64 with stationary contact 58 affixed to its upper end is electrically connected to the mounting bolts 111. When current is flowing through the current interrupter 110, the current flows from the trigger arm assembly 30 through the first lever arm 38 and down the contact rod 46, through the movable contact 56, the stationary contact 58, metallic sleeve 64 and out the mounting bolts 111.

On the exterior of the current interrupter 110, the shaft 32 protrudes away from the body of the enclosing portion 14 and connects to the trigger arm assembly 30. Trigger arm assembly 30 is fastened on the end of the shaft 32 by a pin 33. At the other end of the shaft 32 is an arc shaped tab 37 and the guide spring mount 41, which extend through the first lever arm 38.

As explained previously, the shaft 32 rotates counterclockwise when the swing arm assembly 120 contacts the opening handle 140 of the trigger arm assembly 30. When the shaft 32 rotates, tab 37 also rotates and the charging spring 29 begins to wind. The charging spring 29 is wound by an amount defined by the angular displacement θ shown in FIG. 4. In one embodiment, the angular displacement θ a is approximately 30°. This corresponds to the amount of rotation experienced by the shaft 32 when the opening handle 140 (FIG. 3A) traverses down the conductive portion 136 to point 138 of the driving bracket 130. When the opening handle 140 reaches point 138, the shaft 32 has rotated through the angular displacement θ. When the driving bracket 140 has reached point 138, the edge of the tab 37 contacts the upper portion 57 of the first lever arm 38. As shaft 32 continues to rotate beyond the angular displacement θ, the rotation of tab 37 forces the first lever arm 38 to move in an upward direction. As the first lever arm 38 rotates upward, the moveable contact 56 starts to move along the stationary contact 58.

When the first lever arm 38 and the second lever arm 42 are roughly parallel, the tension of the guide springs 50 is greatest. As the first lever arm 38 moves beyond this point, the charging spring 29 releases and causes the first lever arm 38 to rotate rapidly. The rotational force provided when the charging spring 29 releases together with the compresssional force applied by the guide springs 50 causes the moveable contact 56 to separate from the stationary contact 58 faster than it would without the charging spring 29. One advantage of the present invention is that when the charging spring 29 releases, the first lever arm 38, and ultimately the moveable contact 56, accelerate through the angular displacement θ. In the previous current interrupters, such as those described in the '129 or the '654 patents, the first lever arm is interlocked to the shaft and is not able to accelerate independently from the shaft. As the moveable contact 56 separates from the stationary contact 58, the current flow through the current interrupter 110 is interrupted. Any arcing gases associated with the separation of the moveable contact 56 and stationary contact 58 is directed towards the muffler portion 18 of the current interrupter 110.

When the current interrupter 110 closes, as shown in FIG. 3B, the shaft 32 rotates in a clockwise manner. The clockwise rotation of the shaft 32 causes the tab 37 to contact the first lever arm 38 which moves the first lever arm 38 in a downward direction. This in turn causes the second lever arm 42 to move in a downward direction causing the contact rod 46 to move in a downward direction. The downward movement of the contact rod 46 causes the moveable contact 56 to touch the stationary contact 58 and the current interrupter 110 is reset.

FIG. 8 is a complementary view of FIG. 4 with all of the internal operating components and the muffler portion 18 removed. The operating mechanism enclosing portion 14 of housing 12 is fabricated with a hollow interior that is adapted to receive the internal operating components of the current interrupter 110. A round opening 204 is molded into the housing 12 to receive an insert 203. In one embodiment of the present invention, the insert 203 is a metal ring that is molded into the opening 204. The insert 203 is designed to receive the shaft 32 and provide a seal when the shaft is inserted. A groove 206 is molded into the interior wall of the operating enclosing portion 14. Groove 206 receives one end of guide pin 48. Bolt holes 214 receive bolts 24 when the cover 22 is attached to the operating mechanism enclosing portion 14.

FIG. 9 displays a front view of cover 22. In cover 22, there is a groove 208 located at a position exactly opposite groove 206 in operating mechanism enclosing portion 14 when cover 22 is attached. When the interrupter 110 is assembled, Cover 22 also has a recess 210 for receiving the guide pin 48. Attached circumferentially around the cover 22 is a gasket 213. Gasket 213 is made of a non-conductive compressible material to allow the cover 22 to be sealed to the operating mechanism enclosing portion 14. Also formed through cover 22 are bolt holes 212 which align with bolt holes 114.

It is to be understood that the foregoing description has been provided merely for the purpose of explanation and is in no way to be construed as limiting of the invention. Where the invention has been described with reference to embodiments, it is understood that the words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A driving bracket for use in an electrical switch assembly, said driving bracket mounted on a swing arm of said electrical switch assembly and providing an electrical current path to a trigger arm assembly of a current interrupter mounted on said electrical switch assembly, said driving bracket comprising:
a conductive portion which makes electrical contact with said trigger arm assembly when said swing arm moves from a first position to a second position.

2. The driving bracket of claim 1 further comprising a nonconductive portion which makes contact with said trigger arm assembly when said swing arm moves from said second position to said first position.

3. The driving bracket of claim 1 wherein said conductive portion makes electrical contact with an opening handle of said trigger arm assembly.

4. The driving bracket of claim 2 wherein said nonconductive portion makes contact with a closing handle of said trigger arm assembly.

5. The driving bracket of claim 1 wherein said conductive portion is offset from said nonconductive portion.

6. The driving bracket of claim 5 wherein said offset is a predetermined distance.

7. The driving bracket of claim 1 wherein said first position is a closed position and the electrical switch assembly is conducting current.

8. The driving bracket of claim 1 wherein said second position is an opened position and the electrical switch assembly is not conducting current.

9. The driving bracket of claim 1 wherein said movement of said swing arm assembly from said first position to said second position causes said trigger arm assembly to rotate causing said current interrupter to open.

10. The driving bracket of claim 2 wherein said movement of said swing arm assembly from said second position to said first position causes said trigger arm assembly to rotate causing said current interrupter to close.

11. A current switch assembly for use in the power transmission and distribution industry said current switch assembly comprising:
a swing arm assembly;
a driving bracket mounted on said swing arm assembly, said driving bracket comprising a conductive portion;
a current interrupter mounted on said current switch assembly, said current interrupter comprising a trigger arm assembly;
wherein electrical current flows through said current interrupter when said conductive portion makes electrical contact with said trigger arm assembly as said swing arm assembly moves from a first position to a second position.

12. The current switch assembly of claim 11 wherein said driving bracket further comprises a nonconductive portion which makes contact with said trigger arm assembly when said swing arm assembly moves from said second position to said first position.

13. The current switch assembly of claim 11 wherein said conductive portion makes electrical contact with an opening handle of said trigger arm assembly.

14. The current switch assembly of claim 12 wherein said nonconductive portion makes contact with a closing handle of said trigger arm assembly.

15. The current switch assembly of claim 11 wherein said conduction portion is offset from said nonconductive portion.

16. The current switch assembly of claim 15 wherein said offset is a predetermined distance.

17. The current switch assembly of claim 11 wherein said first position is a closed position and the electrical switch assembly is conducting current.

18. The current switch assembly of claim 11 wherein said second position is an opened position and the electrical switch assembly is not conducting current.

19. The current switch assembly of claim 11 wherein said movement of said swing arm assembly from said first position to said second position causes said trigger arm to rotate causing said current interrupter to open.

20. The current switch assembly of claim 12 wherein said movement of said swing arm assembly from said second position to said first position causes said trigger arm to rotate and causes said current interrupter to close.
